(19) United States
(12) Patent Application Publication
(10) Pub. No.: US 2025/0307005 A1
(43) Pub. Date: Oct. 2, 2025

(54) METHODS AND APPARATUS TO ACCESS FEDERATED RESOURCES

(71) Applicant: Cloudera, Inc., Santa Clara, CA (US)

(72) Inventors: Lawrence Joseph McCay, Cherry Hill, NJ (US); Harrison Joseph Sheinblatt, Millbrae, CA (US); Philip John Zampino, Fuquay Varina, NC (US)

(21) Appl. No.: 18/618,689

(22) Filed: Mar. 27, 2024

(51) Int. Cl. G06F 9/50

(52) U.S. Cl. CPC G06F 9/5027

(57) ABSTRACT

Disclosed examples include transmitting a discovery result to a client application, the discovery result including a list of federated data lakes; and after receiving a token request specifying a first data lake of the federated data lakes, transmitting an access token and metadata to the client application. The access token and the metadata corresponding to the first data lake. The metadata specifies services available at the first data lake. The access token grants the client application access to the first data lake of the federated data lakes.

### FIELD OF THE DISCLOSURE

This disclosure relates generally to network-based computers and, more particularly, to methods and apparatus to access federated resources.

### BACKGROUND

A network environment may be used to connect users to distributed resources such as data and compute resources. Username and password credentials may be required from users to allow such accesses. Types of network environments include hybrid network environments and multi-cloud environments. In hybrid environments, some data and compute resources are in a network or cloud hosted on premises and other data and compute resources are hosted in a cloud maintained by a cloud provider service. Multi-cloud environments are formed of two or more clouds maintained by two or more cloud service providers.

### BRIEF DESCRIPTION OF THE DRAWINGS

FIG. 1 is a block diagram of an example resource federation system to implement an example federated resource protocol.

FIG. 2 is an example messaging exchange between a client application and a federation repository during a discovery process of a federated resource protocol.

FIG. 3 is an example messaging exchange between a client application and a federation repository during a resource access process of a federated resource protocol.

FIG. 4 is a block diagram of an example implementation of the federation repository server of FIGS. 1-3.

FIGS. 5A and 5B are block diagrams of example implementations of a service access endpoint of FIG. 1.

FIG. 6 is a block diagram of an example implementation of the client application of FIGS. 1-3.

FIG. 7 is a flowchart representative of example machine-readable instructions and/or example operations that may be executed, instantiated, and/or performed by example programmable circuitry to implement the federation repository server of FIGS. 1-4 and/or the client application of FIGS. 1-3 and 6 to discover federated resources during a discovery process of a federated resource protocol.

FIG. 8 is a flowchart representative of example machine-readable instructions and/or example operations that may be executed, instantiated, and/or performed by example programmable circuitry to implement the federation repository server of FIGS. 1-4, the client application of FIGS. 1-3 and 6, and/or the service access endpoint of FIGS. 1, 5A, and/or 5B during a resource access process of a federated resource protocol.

FIG. 9 is a block diagram of an example processing platform including programmable circuitry structured to execute, instantiate, and/or perform the example machine-readable instructions and/or perform the example operations of FIGS. 7 and/or 8 to implement the federation repository server 102 of FIG. 4, the service access endpoint 110a of FIGS. 5A and/or 5B, and the client application 108 of FIG. 6

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 7 and/or 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

### DETAILED DESCRIPTION

Examples disclosed herein federate resources across multiple deployments in a network environment and coordinate issuance of normalized federation access tokens to users as part of resource access processes. In examples disclosed herein, a normalized federation access token authorizes a corresponding user to access multiple federated resources across different deployments. For example, an organization may deploy multiple data lakes across one or more networks. In a local data lake registration model (e.g., a home data lake registration model), the organization registers users with one or more of the deployed data lakes. Under this model, a local data lake or a home data lake is a deployment with which a user's user credentials are registered. As such, one user of the organization may be registered to access resources of one data lake and another user of the organization may be registered to access resources of another data lake. To enable the users of the organization to access resources across multiple ones of the data lakes in addition to their local or home data lake, examples disclosed herein register the data lakes and their resources in a federation repository. Examples disclosed herein also record privileges of the users that define what deployed data lakes and/or resources the users are authorized to access. In this manner, when a user is authenticated, examples disclosed herein issue a normalized federation access token as part of a federated resource protocol. The normalized federation access token provides identity-level compatibility for use in a federated deployment so that it is useable to access a federated data lake and/or a resource for which the user has an access privilege. By issuing a normalized federation access token, the access token issued to the user can be used to access a remote federated deployment because the local data lake with which the user's user credentials are registered is one of the federated deployments.

Examples disclosed herein may be used to access federated resources that are deployed in single network environments (e.g., single cloud environments), hybrid network environments (e.g., hybrid cloud environments), and/or multi-network environments (e.g., multi-cloud environments). In a single network environment, resources may be deployed solely in a single private network such as an on-premises network or solely on a network that is maintained at one or more data centers for a tenant. In some examples, a single network environment is implemented as a cloud environment that is solely on premises or hosted at one or more data centers. In a hybrid network environment, some resources are deployed locally in an on-premises network and other resources are deployed remotely in a network hosted at a data center and/or at another location separate from the location of the on-premises network. In some examples, a hybrid network environment is implemented as a hybrid cloud in which a portion of the cloud is hosted on premises and another portion of the cloud is hosted at a data center (e.g., by a third-party cloud service provider (CSP)). In a multi-network environment, resources may be deployed in separate networks maintained by different parties (e.g., by different service providers). In some examples, a multi-network environment is implemented as a multi-cloud environment in which a tenant leases multiple cloud environments from different CSPs and allows its users to access resources deployed across the multiple cloud environments.

In examples disclosed herein, resources may be data, compute resources, and/or device resources (e.g., storage resources, database resources, etc.), and/or services. In examples disclosed herein, compute resources enable submission and execution of jobs in a distributed system. For example, in hybrid network environments and multi-network environments, both data and compute capabilities may be accessed across deployments on both platforms. In a hybrid network environment, on-premises data can be burst to a cloud resource seamlessly based on access authorizations applied uniformly across on-premises and remote resources. In examples disclosed herein, similar behavior can be achieved for resources deployed across multiple networks (e.g., a multi-network environment) or multiple clouds (e.g., a multi-cloud environment) by using normalized federation access tokens. That is, by federating resources and using normalized federation access tokens, as disclosed herein, access privileges can be applied uniformly for different resources regardless of such resources being deployed in different networks or clouds.

Examples disclosed herein facilitate accessing resources or data housed and protected in an on-premises data lake using applications that are migrated to a cloud environment. Examples disclosed herein may be used to comply with corporate and/or governmental data privacy policies by managing secure accesses to data in an on-premises data lake from applications running in cloud environments. An example of such a governmental data privacy policy applicable to digital data is the General Data Protection Regulation (GDPR) which is a privacy and security law legislated by the European Union (EU).

When the same data is used by applications running in multiple cloud environments, using example normalized federation access tokens, as disclosed herein, substantially reduces or eliminates the need for data replication. For example, the need to replicate data across multiple storage resources is substantially reduced or eliminated. In addition, the need to replicate data policies that protect the data is substantially reduced or eliminated. Also, the need to replicate and maintain synchronizations of metadata for the same data across all deployments is substantially reduced or eliminated.

In some examples, data is stored in a remote data lake. As used herein, a remote data lake is a deployment separate from a local data lake (or home data lake) of a user. A local data lake may be on premises or in a cloud. A remote data lake is at a separate network location from the local data lake and/or in a cloud. In some examples, the remote data lake is at a different geographic location relative to the local data lake. When data is in a remote data lake, examples disclosed herein facilitate leveraging compute capabilities that are co-located with or adjacent to the data and facilitate directing results to a local data lake location (e.g., an on-premises location) or other data lake location. In addition, example normalized federation access tokens disclosed herein facilitate normalizing user authentication and identity details in a given data lake (e.g., a local data lake) and syndicating recognition of such user authentication and identity details by other data lakes (e.g., remote data lakes) in a secure and trusted manner.

Examples disclosed herein also enable application developers to discover federated data lakes available to them while an application is being developed for any given data lake runtime. Examples disclosed herein also enable authorizing access to data sets for consumption by authorized users without also providing access to non-authorized users.

Examples disclosed herein enable users to discover unstructured, semi-structured, and structured data and compute capabilities of data lakes available to them across public, private, and/or multi-cloud platforms. In examples disclosed herein, a user can seamlessly, transparently, and securely acquire credentials (e.g., an access token) to authenticate to each individually secured data lake from a given client operating environment. By allowing access to such credentials using a secure discovery application programming interface (API) and token exchange protocol, examples disclosed herein leverage the acquired credentials to provide a user with access to the data and corresponding services (e.g., a storage service, a compute service, structured query language (SQL) service, etc.) of one or more federated data lakes in a manner that is intuitive to the user. In such manner, examples disclosed herein allow for more efficient use of resources (e.g., data, storage resources, compute resources, database resources, services, etc.) across different data lakes.

By federating data lakes, examples disclosed herein minimize the need for data duplication. That is, since a user can access data in any authorized data lake that is federated, such data does not need to be duplicated from a remote data lake to a local data lake for that user. Instead, federating allows the user to access the data in one federated data lake from another federated data lake. Using this increased data accessibility in a client environment increases consumption and stickiness for that data in the client environment. For example, data consumption is increased because a user can more seamlessly access data across multiple remote federated data lakes from a local authorized data lake. Stickiness is increased because a user is more likely to continue using the federated data lakes over time to access data. That is, when such data accesses across the multiple data lakes are seamless and do not increase the level of effort for the user, the level of technical knowledge needed by the user for such data accesses is decreased and the user experience is improved.

As described below, examples disclosed herein use a pattern of token exchange to discover service paths and/or protocols to securely access services (e.g., local services or remote services) in federated data lakes. Such secure accesses are accomplished through access tokens and endpoint metadata that could be used for any number of services, APIs, and clients.

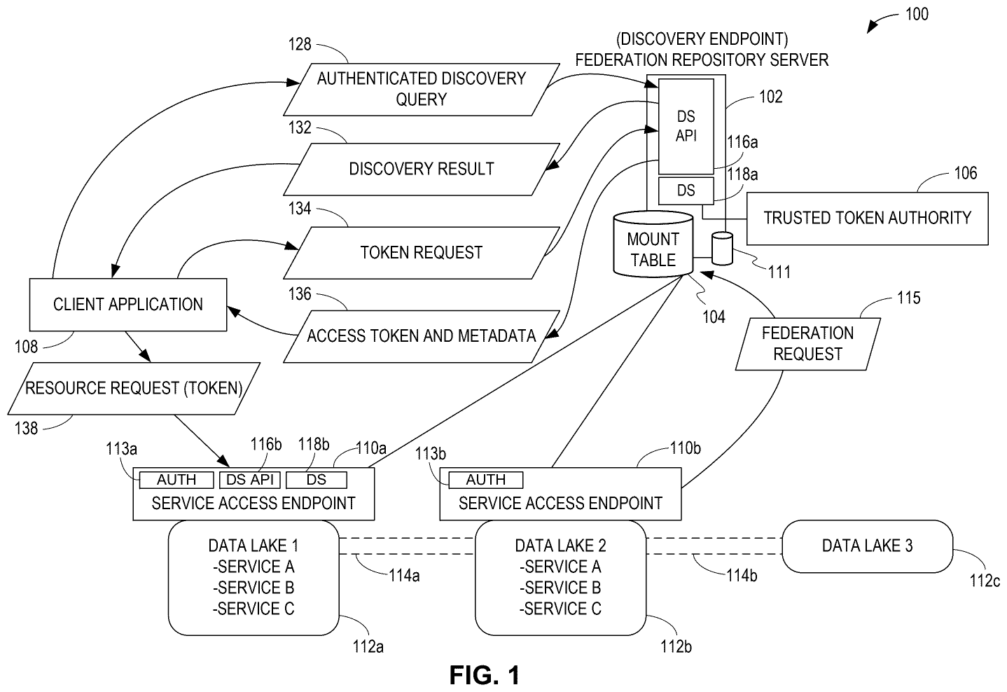

FIG. 1 is a block diagram of an example resource federation system 100. The resource federation system 100 includes an example federation repository server 102, an example mount table 104, an example trusted token authority 106, an example client application 108, example service access endpoints 110a-b, and example data lakes 112a-c. In examples disclosed herein, each of the data lakes 112a-c is a deployment. The data lakes 112a-c may be deployed across one or more networks. In example FIG. 1, one or more of the data lakes 112a-c may be in a single network environment (e.g., an on-premises network, a single cloud environment), one or more of the data lakes 112a-c may be in a hybrid network environment (e.g., a hybrid cloud environment), and/or one or more of the data lakes 112a-c may be in a multi-network environment (e.g., multi-cloud environment). Also in FIG. 1, the data lakes 112a-c may be in different ones of private clouds and public clouds. For example, the first data lake 112a may be in a private cloud and the second data lake 112b may be in a public cloud. In addition, in some examples, the client application 108 is in a cloud environment separate from cloud environments of the data lakes 112a-c. For example, the client application 108 may be in one cloud environment and use examples disclosed herein to access the data lake 112a and its resources in another cloud environment separate from the cloud environment of the client application 108.

In examples disclosed herein, the data lakes 112a-c are federated data lakes. As such, the data lakes 112a-c are also referred to herein as federated data lakes 112a-c. The federated data lakes 112a-c may have homogeneous or heterogeneous identities and user populations. For example, a homogeneous identity of a data lake refers to that data lake serving a single purpose or only accessible by a single type of user or organization. A heterogeneous identity of a data lake refers to that data lake serving multiple purposes and/or being accessible by different types of users or organizations. A homogeneous user population is a user population in which all of its users correspond to a single user class or single user type. A heterogenous user population is a user population in which some or all of its users correspond to multiple user classes or multiple user types. In a business environment, example organizations may include an engineering department, a human resources department, a marketing department, etc. In such examples, user classes or user types in a business environment may include an engineering user type of an engineering department, a human resource user type of a human resources department, a marketing user type of a marketing department, etc. In the medical industry, example user classes or user types may include a physician user type of a physician group, a nurse user type of a nurse group, an administration user type of an administration group, a patient user type of a patient group, etc.

In examples disclosed herein, a user of the client application 108 is registered with one of the data lakes 112a-c as its local data lake or home data lake. As part of such local registration, the user is issued local-level user credentials to access the local data lake or home data lake. When the local data lake deployment is federated with other data lake deployments, a federated resource protocol enables the client application 108 to access other federated deployments based on the local-level user credentials of the user. For example, if the first data lake 112a is the local data lake of a user of the client application 108, the user credentials of that user are registered at the first data lake 112a to access resources in the first data lake 112a. After the data lakes 112a-c are federated in the mount table 104, the federated resource protocol disclosed herein allows the client application 108 to use the user credentials to access resources in the second data lake 112b and/or the third data lake 112c from the local, first data lake 112a.

The data lakes 112a-c store data (e.g., in data tables) accessible by authorized users. In addition, some of the data lakes 112a-c include resources such as services (e.g., capabilities) that may be used to organize, search, process, etc. the data. For example, the first data lake 112a includes corresponding services A, B, C, and the second data lake 112b includes corresponding services A, B, C. Although the third data lake 112c is shown without services, the third data lake 112c may include services or may include only data tables. When the data lakes 112a-c are federated, such federation redefines the boundaries of each data lake platform deployment to include access to the resources in others of the data lake platform deployments. As such, even if the third data lake 112c does not have services, the federation of the third data lake 112c with the other data lakes 112a-b allows a user registered in the third data lake 112c to access the services of the first and second data lakes 112a-b based on that user's authorization to access the third data lake 112c and based on the data lakes 112a-c being federated.

In some examples, the federated resource protocol disclosed herein is used to provide access to the services without a user needing to specify particular data to be accessed. In some such examples, the services include data stored in the data lakes 112a-c. As such, when the client application 108 requests access to a service of the data lakes 112a-c, such access to the service allows access to corresponding data so that the client application 108 may use the service to view and/or process the corresponding data.

Examples disclosed herein register the data lakes 112a-c as federated data lakes using the federation repository server 102. The federation repository server 102 is a discovery endpoint that maintains security policies and user authorizations database 111 to identify authorizations or permissions of users to access particular resources. For example, the security policies and user authorizations database 111 may specify that a user type may access all data in a data table or only specific data in the data table (e.g., specific rows and/or columns of data). The security policies and user authorizations database 111 may also be used to specify the type of accesses of different user types to different data. For example, one user type (e.g., engineering users) may have read/write access to particular data in a data table (e.g., a software development specifications data table) and another user type (e.g., marketing users) may have read-only access to that particular data.

When registered by the federation repository server 102, federated access connections are established between the federated data lakes 112a-c as part of their federation. Such federated access connections are represented in FIG. 1 as passthrough accessways 114a-b. In examples disclosed herein, the passthrough accessways 114a-b are inter-deployment connections (e.g., secure channels) such as logical connections or physical connections created via one or more networks between the data lakes 112a-c to allow transfer of messages, data, and/or any other information between the data lakes 112a-c. That is, due to the federation of the data lakes 112a-c by the federation repository server 102, resources in one of the data lakes 112a-c are discoverable and accessibly by users of another one of the data lakes 112a-c. For example, based on federated access connections represented by the passthrough accessways 114a-b, authorized users of one data lake can discover and access resources of another data lake. That is, if a user receives an access token to access the first data lake 112a, that user can access resources that the user is authorized to access in the first data lake 112a. In addition, based on the passthrough accessway 114a between the first and second data lakes 112a-b, the user can access resources that the user is authorized to access in the second data lake 112b by sending requests from the first data lake 112a to the second data lake 112b for such resources.

Examples disclosed herein also provide principal mapping to establish appropriate security contexts of receiving ends of federated requests for authorization decisions and audit purposes. To do this, the resource federation system 100 implements a secure discovery service API and federated resource protocol useable by the client application 108 to initiate an authenticated and authorized discovery of federated services, published interfaces, access tokens, target uniform resource locators (URLs), and client configurations and/or binaries that are needed to access data (e.g., data tables in the data lakes 112a-c) or services (e.g., services of the data lakes 112a-c) across hybrid cloud and multi-cloud deployments of the data lakes 112a-c.

In example FIG. 1, the first data lake 112a and the second data lake 112b are provided with corresponding service access endpoints 110a-b. The third data lake 112c is shown as not implementing a service access endpoint to illustrate an example in which some federated data lakes may not implement service access endpoints but are still accessible through service access endpoints of other federated data lakes. For example, the service access endpoint 110a (or the service access endpoint 110b) may receive a resource request to access data or other resource in the third data lake 112c. Through federation techniques disclosed herein, the service access endpoint 110a confirms authorization for such access and establishes the access to the third data lake 112c through an inter-deployment connection such as the passthrough passageways 114a-b. Accordingly, examples disclosed herein may be implemented in connection with environments having multiple deployments (e.g., data lakes) and in which only one deployment implements a service access endpoint (e.g., similar or identical to the service access endpoints 110a-b) or less than all of the deployments implement service access endpoints. In such implementations, a service access endpoint of one federated deployment can be used to provide access to multiple federated deployments. For example, in the resource federation system 100, the service access endpoint 110b may be omitted and the second data lake 112b and the third data lake 112c may be accessed through the service access endpoint 110a implemented at the first data lake 112a. In other examples, techniques disclosed herein may be implemented in an environment having multiple deployments and in which all deployments implement corresponding service access endpoints.

The service access endpoints 110a-b provide communication interfaces (e.g., gateway interfaces) and authentication and authorization (AUTH) controllers 113a-b to allow authorized accesses to resources in the data lakes 112a-c. To federate a data lake 112a-c, a service access endpoint 110a-b sends a federation request to the federation repository server 102. For example, an example federation request 115 is shown as sent by the second service access endpoint 110b to the federation repository server 102. Although the federation request 115 is sent by the second service access endpoint 110b, the federation request 115 may be to federate any of the data lakes 112a-c. In response, the federation repository server 102 (e.g., a discovery service 118a in the federation repository server 102) registers a mount or mount name as a moniker of the subject data lake 112a-c in the mount table 104 so that the data lake 112a-c is part of a federation.

The mount table 104 stores data lake mount names, corresponding target URL paths of the data lakes 112a-c, and metadata of resources in ones of the data lakes 112a-c. When a new data lake is federated, information or metadata of that data lake is added to the mount table 104 so that it can be shared with client applications (e.g., the client application 108) during a discovery process. Similarly, when a data lake is removed from federation, the information entries of that data lake are removed from the mount table 104. In this manner, a federation can be dynamically scaled up or scaled down by modifying the mount table 104 without requiring action by client applications or other federated data lakes.

To allow the federated data lakes 112a-c to operate as part of a federation, the authentication and authorization (AUTH) controllers 113a-b analyze requests to access those federated data lakes 112a-c. For example, the AUTH controllers 113a-b include authorization policies that they enforce against tokens by performing authentication and authorization processes to confirm that the users originating the requests are authorized to access the requested resources. For example, during authentication events handled by the AUTH controller 113a, the AUTH controller 113a receives client-side credentials (e.g., credentials provided by the client application 108) and normalized access tokens from the client application 108 that can be used to access services at the federated data lakes 112a-c corresponding to those access tokens. The AUTH controllers 113a-b perform authentication using client-based authentication, which may be implemented using, for example, the Kerberos network authentication protocol developed by Massachusetts Institute of Technology (MIT) Kerberos Consortium, the hypertext transfer protocol (HTTP) Basic authentication protocol against lightweight directory access protocol (LDAP)/active directory (AD) (LDAP/AD), the Kubernetes API, native operating system (OS) authentication, or any other suitable authentication service for a client environment.

The example federation repository server 102 normalizes client environment authentication requirements for a data lake 112a-c into a normalized or standardized access token for cross-data lake federation so that one granted access token can be used by the client application 108 to access services in any of the data lakes 112a-c. For example, the federation repository server 102 normalizes an access token by translating an authentication event via any number of authentication protocols or mechanisms into a single access token format and set of related claims. The normalized access token in a particular format makes that access token usable to access a corresponding one of the federated data lakes 112a-c. A normalized access token is not usable to directly access all of the data lakes 112a-c in the federation. Instead, a claim in the access token declares which of the federated data lakes 112a-c can be accessed using that normalized access token. The claim of the access token also declares the resources in any of the data lakes 112a-c that can be accessed using the normalized access token. As such, a normalized access token corresponding to one data lake can be used to access a service in another data lake through federated access represented by the passthrough accessways 114a-b so long as the access is requested from the data lake declared by the claims of the access token.

In example FIG. 1, an example discovery service (DS) API 116a-b and a corresponding discovery service (DS) 118a-b may be implemented in one or more of the federation repository server 102, the first service access endpoint 110a, or the second service access endpoint 110b. The discovery service APIs 116a-b and the corresponding discovery services 118a-b are provided to allow the client application 108 to discover federated deployments (e.g., the data lakes 112a-c) and request accesses to those deployments and their resources. Although two discovery service APIs 116a-b and two corresponding discovery services 118a-b are shown in example FIG. 1, in other examples, only a single discovery service API and a single corresponding discovery service may be implemented in the resource federation system 100 and all discovery requests are sent by the client application 108 to that discovery service API and corresponding discovery service. For example, only the discovery service API 116a and the discovery service 118a may be provided in the federation repository server 102 and the discovery service API 116b and the discovery service 118b may be omitted from the first service access endpoint 110a. Alternatively, only the discovery service API 116b and the discovery service 118b may be provided in the first service access endpoint 110a, and the discovery service API 116a and the discovery service 118a may be omitted from the federation repository server 102. Accordingly, any description herein related to either of the illustrated example discovery service APIs 116a-b is substantially similarly or identically applicable to the other one of the discovery service APIs 116a-b. Similarly, any description herein related to either of the illustrated example discovery services 118a-b is substantially similarly or identically applicable to the other one of the discovery services 118a-b.

In some examples in which the discovery service API 116a and the discovery service 118a are omitted from the federation repository server 102, the discovery service API 116b and/or the discovery service 118b of the service access endpoint 110a access the mount table 104 in the federation repository server 102. Alternatively, in other examples, the federation repository server 102 is omitted from the resource federation system 100, the mount table 104 is implemented in the service access endpoint 110a at which the discovery service API 116b and the discovery service 118b are implemented. In such examples, the security policies and user authorizations database 111 is also implemented in the service access endpoint 110a.

When the discovery service API 116a receives a request for a token to access a deployment such as a data lake 112a-c, the discovery service 118a confirms whether that attempt to perform a federated access of that data lake 112a-c is authorized. In this manner, the discovery service 118a eliminates or reduces the likelihood of granting unauthorized accesses. The discovery service 118a uses authorization policies (e.g., the security policies and user authorizations database 111) corresponding to the data lakes 112a-c to determine whether an authenticated user at the client application 108 is allowed to access federated services in those data lakes 112a-c before issuing an access token or related metadata to the authenticated user. Additional authorization is performed by the AUTH controllers 113a-b in the service access endpoints 110a-b to ensure that the user has access to the specific resources being requested as determined by the authorization policies of the data lakes 112a-c being accessed.

Through the discovery service APIs 116a-b, standard Interfaces for data and services of the data lakes 112a-c and associated clients (e.g., the client application 108) and/or programming models are published and available to all federated data lake peers (e.g., the federated data lakes 110a-c). In addition, the discovery service APIs 116a-b and the discovery services 118a-b enable a highly scalable federation. For example, when a new data lake seeks to join a federation, the discovery service APIs 116a-b use, for example, a wireless local area network (WLAN)-friendly peer discovery protocol to enable authenticated and authorized registration of that data lake peer in the mount table 104. An example of such a peer discovery protocol is an epidemic protocol. After the new data lake peer is registered in the mount table 104, the federation repository server 102 propagates the metadata of the new data lake peer across the federation.

The discovery service APIs 116a-b implement a token exchange pattern for normalizing local authentication events and identities (e.g., authentications and identity verifications performed by the service access endpoints 110a-b of the data lakes 112a-b) into a normalized and canonical access token. The normalized and canonical access token can be cryptographically verified by the AUTH controllers 113a-b in the service access endpoints 110a-b. The normalized and canonical access token also includes sufficient details about a user to enable the AUTH controllers 113a-b to perform group lookups and authorizations for accesses to requested resources. The normalized and canonical access token also includes sufficient details to enable the AUTH controllers 113a-b to perform an audit of authorizations on a corresponding user. The normalized and canonical access token may also be used by the AUTH controllers 113a-b to limit access to a single data lake peer (e.g., one of the data lakes 112a-c) specified by a claim of the token to limit a blast radius of a compromised token. The normalized and canonical access token may also include expiration information to implement a limited lifespan of that token. This can also limit damage that could result from a compromised token.

The resource federation system 100 includes an example trusted token authority 106 in communication with the discovery service 118a. In some examples, the discovery service 118b in the service access endpoint 110a communicates with the trusted token authority 106 directly or through the federation repository server 102. The trusted token authority 106 issues access tokens (e.g., normalized and canonical access tokens) that are authenticated to authorize users (e.g., a user of the client application 108) to access resources in the federated data lakes 112a-c. Such access tokens may be implemented using any suitable type of token. In some examples, access tokens can be implemented using JavaScript Object Notation (JSON) Web Tokens (JWTs). For example, using such a JWT-based identity context, the client application 108 can verify the normalized and canonical access token at a receiving side through use of the mount table 104 in combination with a JSON Web Key Set (JWKS) uniform resource locator (URL) encoded within the token. This allows for the client application 108 to acquire a public key from a remote URL that is inherently trusted due to being able to qualify the URL as being within a data lake 112a-c that is a member of the federation. In some examples, each federated data lake 112a-c expects a specific audience claim for that data lake and does not accept any tokens that do not contain that claim.

The discovery services 118a-b and their corresponding discovery service APIs 116a-b of FIG. 1 provide the flexibility to accommodate the evolution of services in a big data and data lake ecosystem based on wire protocols, normalized access token format, and data lake metadata used by the discovery service APIs 116a-b. Constructs within message payloads between the client application 108, the federation repository server 102, and/or the service access endpoints 110a-c are readable by all of the discovery service APIs 116a-b. In this manner, any of the APIs 116a-b or any client (e.g., the client application 108) with specific knowledge of what an interaction requires is able to discover attributes and/or access requirements corresponding to requested data lakes and/or resources. As such, examples disclosed herein implement a framework for discovery of interfaces, client metadata, and access tokens associated with multiple federated data lakes such as the federated data lakes 112a-c.

The federated resource protocol disclosed herein includes a discovery process and a resource access process. The federated resource protocol is based on a federation of the data lakes 112a-c being registered in the mount table 104 with “line of sight”, meaning that the federated data lakes 112a-c are discoverable by authorized users. During the discovery process, the discovery of the federated data lakes 112a-c deployments and corresponding resources (e.g., data, compute resources, device resources, services, etc.) is accomplished using a discovery service (e.g., the discovery services 118a-b) configured and known to federation-aware client applications such as the client application 108.

In examples disclosed herein, there is no need for a client to activate its access to a shared resource via a hyperlink to receive credentials nor is it necessary for a client to receive out-of-band email messages with such hyperlinks or access credentials for federated resources. Such hyperlinking or out-of-band communications could create security weaknesses through which malicious activity could compromise the security of hyperlinks or access credentials such as access tokens.

By virtue of the user of the client application 108 having user credentials to authorize access to a local deployment (e.g., a local one of the data lakes 112a-c) that is federated with one or more other deployment(s) (e.g., others of the data lakes 112a-c), the federated resource protocol disclosed herein allows the client application 108 to use those user credentials to communicate with discovery services 118a-b at a discovery endpoint, such as the federation repository server 102, and/or at a service access endpoint, such as the service access endpoint 110a. Through such communications, the client application 108 can request discovery of the additional one or more federated deployments registered in the mount table 104 and acquire access tokens from the discovery services 118a-b. The access tokens are usable to access resources across the federation of deployments as part of the federated resource protocol. That is, the federated resource protocol normalizes the local authentication at the local, first data lake 112a across the other federated data lakes 112b-c to allow accesses to resources across such federated entities based on identity-level compatibility across the federated identities.

The example federated resource protocol disclosed herein involves message exchanges between a discovery service (e.g., the discovery services 118a-b) and the client application 108 over a network in substantially real time. Such message exchanges of the federated resource protocol allows discovery of accessible data lake deployments and corresponding resources of a federation. The message exchanges also allow obtaining access tokens to access such deployments and/or resources. For example, the federated resource protocol message exchange of FIG. 1 includes an example authenticated discovery query 128, an example discovery result 132, an example token request 134, and an example access token and metadata message 136. In example FIG. 1, the federated resource protocol message exchange is between the client application 108 and the discovery service API 116a at the federation repository server 102 to obtain a discovery result and an access token from the discovery service 118a. However, in other examples, the federated resource protocol message exchange may be implemented in a substantially similar or identical way between the client application 108 and the discovery service API 116b in the service access endpoint 110a to obtain a discovery result and an access token from the discovery service 118b. Accordingly, the example federated resource protocol message exchange illustrated in FIG. 1 may be implemented between the client application 108 and any discovery service API and corresponding discovery service implemented in a federation repository server or a service access endpoint. The client application 108 may use any suitable client access interface (e.g., a REST client interface) to access the discovery service API 116a. For example, the client application 108 may be programmed to include a rich user interface (e.g., a graphical user interface (GUI)) based on the discovery service API 116a so that users can interact with the client application 108 to select data lakes and their resources. Alternatively, the client application 108 may provide a command line interface (CLI) through which a user submits user-typed commands understandable by the discovery service API 116a to select data lakes and their resources.

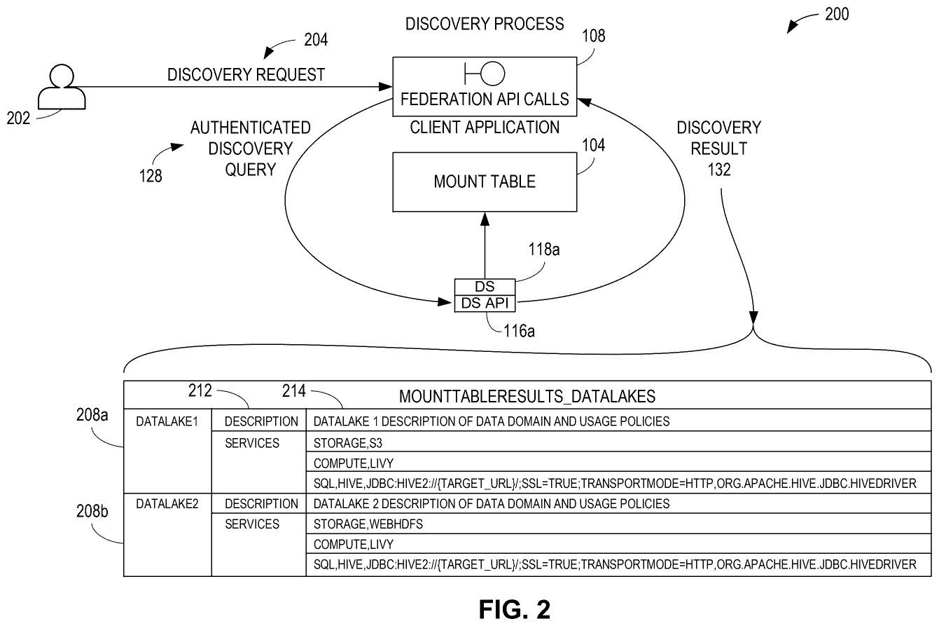

During a discovery process in example FIG. 1, the client application 108 sends a message including the authenticated discovery query 128 to the discovery service API 116a of the federation repository server 102. The authenticated discovery query 128 includes authentication credentials (e.g., a username and password, a time-based password code, a passkey, etc.) of a user that submitted the authenticated discovery request. The discovery service 118a authenticates the user based on the authentication credentials and any suitable authentication protocol. After the authentication credentials are authenticated, the discovery service 118a obtains mount names of the federated data lakes 112a-c and names of corresponding resources from the mount table 104. The discovery service 118a generates the discovery result 132 and adds the data lake mount names and resource names in the discovery result 132. An example implementation of the discovery result 132 is described below in connection with FIG. 2. The discovery service API 116a sends a response message including the discovery result 132 to the client application 108.

The client application 108 selects a data lake from the discovery result 132 and generates the token request 134 that specifies the selected data lake. For example, the first data lake 112a can be a local data lake or a home data lake of the client application 108, and the client application 108 can select to access a remote data lake such as the second data lake 112b. As noted above, a local data lake (e.g., a local deployment), as used herein, refers to a data lake in which user credentials of a user of the client application 108 are registered. This designates that data lake as the home data lake of that user so that if the data lake becomes unfederated the user would still have access to its home data lake but not to other federated data lakes. Similarly, a local resource is a resource in the local data lake in which the user is registered. The client application 108 may operate in the local data lake such as in a virtual machine or a container hosted in a cloud environment that also hosts the local data lake. Alternatively, the client application 108 may be separate from its local data lake and access the local data lake through one or more networks. As noted above, a remote data lake (e.g., a remote deployment), as used herein, refers to a data lake that is separate from a local data lake (or home data lake) of a user. A remote data lake that is federated is accessible by the client application 108 through the federation but is not a home data lake of a user of the client application 108. Similarly, a remote resource is a resource in a remote data lake.

The client application 108 sends a message including the token request 134 to the discovery service API 116a to request an access token to access resources in the selected remote data lake 112b. The discovery service API 116a receives the token request 134, and the discovery service 118a processes the token request 134 for the authenticated user of the client application 108. For example, recognizing the authenticated user, the discovery service 118a requests an access token from the trusted token authority 106 for the selected remote data lake 112b specified in the token request 134. In addition, the discovery service 118a retrieves metadata for that remote data lake 112b from the mount table 104. The discovery service 118a provides the access token from the trusted token authority 106 and the metadata from the mount table 104 to the discovery service API 116a. The discovery service API 116a then sends a response message including the access token and the metadata to the client application 108 which is shown in FIG. 1 as the access token and metadata message 136.

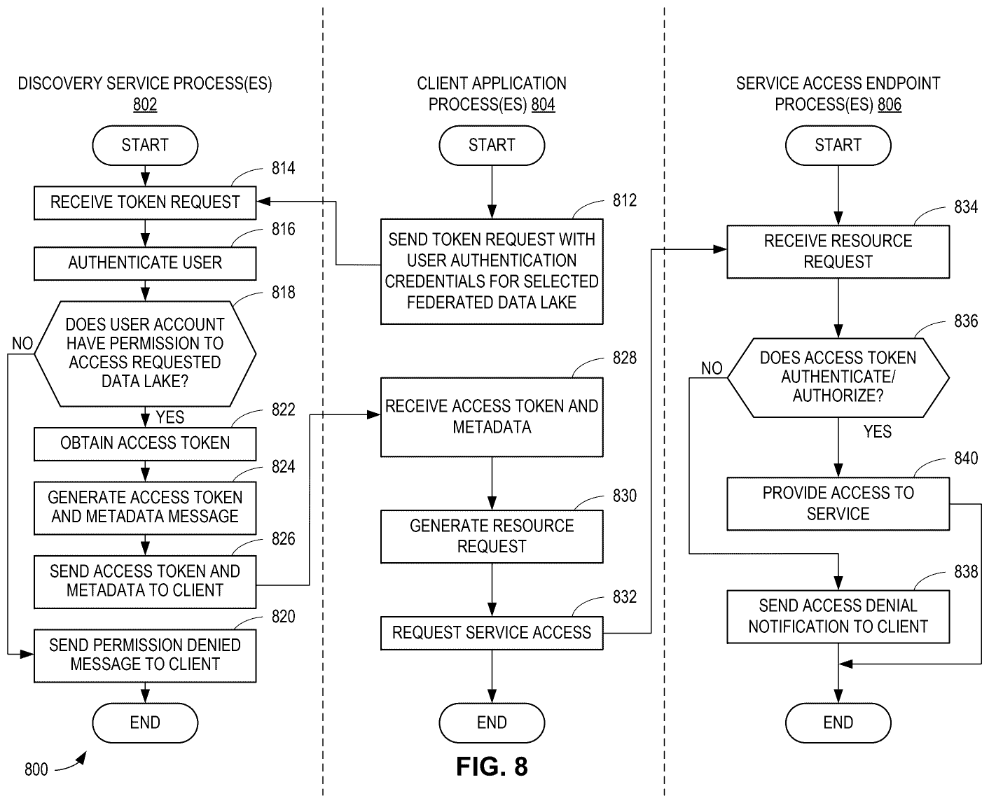

The client application 108 receives the access token and the metadata in the access token and metadata message 136. The client application 108 generates a resource request 138 and includes the access token in the resource request 138. In addition, the client application 108 further qualifies the target URL with a service path in the resource request 138 of a resource in the remote data lake 112b to which the client application 108 is requesting access. An example manner of implementing the resource request 138 is described below in connection with FIG. 8.

The client application 108 sends the resource request 138 to the service access endpoint 110a corresponding to the first data lake 112a. The AUTH controller 113a authenticates the access token and confirms whether a corresponding user is authorized to access the resource corresponding to the service path of the remote data lake 112b provided via the resource request 138. For example, the AUTH controller 113a accesses a policy provided by (e.g., published by) the second service access endpoint 110b and corresponding to the remote data lake 112b. The AUTH controller 113a uses the policy to confirm authorization of the user to access the requested resource and the remote data lake 112b. If the access token authenticates and if the AUTH controller 113a determines that the corresponding user is authorized to access the resource at the remote data lake 112b, the AUTH controller 113a allows the requested access to the resource.

In some examples, the client application 108 may include a service path of a resource of the first data lake 112a in the resource request 138 sent to the first service access endpoint 110a of the first data lake 112a. In such examples, the AUTH controller 113a associated with the first data lake 112a determines whether the user corresponding to the access token is authorized to access the resource of the first data lake 112a. For example, the AUTH controller 113a accesses a policy provided by (e.g., published by) the first service access endpoint 110a and corresponding to the first data lake 112a. The AUTH controller 113a uses the policy to confirm authorization of the user to access the requested resource at the first data lake 112a. If the user is authorized, the AUTH controller 113a allows the requested access by the client application 108 to the resource in the first data lake 112a.

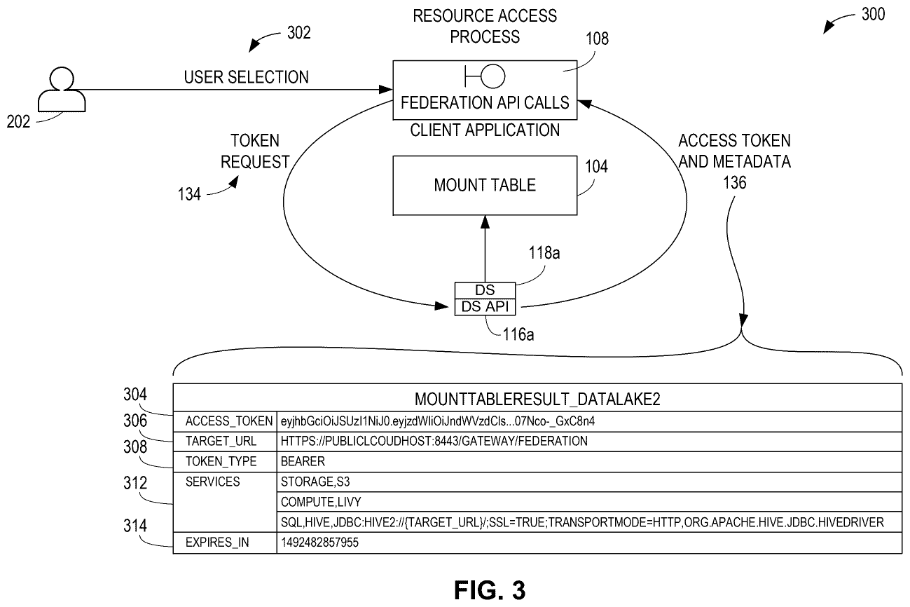

Example operations of the discovery service 118a are described below in connection with FIGS. 2 and 3. That is, FIGS. 2 and 3 illustrate how the discovery service 118a can use the mount table 104 to resolve a mount name of a particular data lake into endpoint metadata and resolve an access token to access that data lake. As noted above, the discovery service 118b may be implemented substantially similarly or identically to the discovery service 118a. Accordingly, the operations described below in connection with the discovery service 118a may be similarly or identically implemented in connection with the discovery service 118b. FIGS. 2 and 3 also illustrate how federation-aware client applications (e.g., the client application 108) are able to resolve a given data lake name into corresponding endpoint metadata and an access token required for access.

FIG. 2 is an example messaging exchange between the client application 108 and the discovery service API 116a during a discovery process 200. Example FIG. 2 is implemented in a client environment in which the client application 108 is used by a user 202 to access information in the mount table 104 via the discovery service API 116a and the corresponding discovery service 118a. The client environment running the client application 108 can be an on-premises cluster or a separately hosted service to perform discovery. The client environment could be hosted within a control plane environment (e.g., a cloud plane that provides management and orchestration across an organization's cloud environment). Additionally or alternatively, the client environment could be a public cloud cluster in which users use a secure socket shell (SSH) or use a browser-based terminal session to access the federation repository server 102. In some examples, the client application 108 may be in a data lake (e.g., one of the data lakes 112a-c). Alternatively, the client environment could be a desktop environment or a mobile device environment that runs the client application 108 with a client configuration and uses network communications to communicate with a deployment (e.g., one of the data lakes 112a-c) as its home deployment. In any case, the client environment may execute a command line interface (CLI) and/or the client application 108. If a CLI is provided, it is used in place of the client application 108 to access the discovery service API 116a using user-provided commands (e.g., user-typed commands) compatible with the discovery service API 116a. If the client application 108 is provided, it is based on a programming library that provides API calls compatible with the discovery service API 116a and may include a GUI to facilitate user interaction.

The client application 108 uses the discovery service 118a to access a data lake. In example FIG. 2, the client application 108 uses federation API calls to interact with the discovery service API 116a. For example, the user 202 can submit a discovery request 204 to the client application 108. In response to the discovery request 204 from the user 202, the client application 108 uses a federation API call to generate the authenticated discovery query 128 of FIG. 1 and causes transmission of the authenticated discovery query 128 to the discovery service API 116a. After the discovery service API 116a receives the authenticated discovery query 128, the discovery service 118a accesses mount names and corresponding service metadata of the federated data lakes 112a-c (FIG. 1) from the mount table 104 (FIG. 1) that are available to be accessed by the level (e.g., user class or user type) of the user credentials of the user 202. The discovery service 118a then lists the results in the discovery result 132 of FIG. 1. The discovery service API 116a causes transmission of the discovery result 132 to the client application 108 in responses to the authenticated discovery query 128.

In example FIG. 2, the discovery result 132 includes data lake entries 208a-b. The first data lake entry 208a includes the mount name of the first data lake 112a, and the second data lake entry 208b includes the mount name of the second data lake 112b. Although only two of the data lakes 112a-c are shown in the discovery result 132, the discovery result 132 may have any number of data lake mount names to represent all federated data lakes that are registered in the mount table 104. The discovery result 132 includes a resources description column 212 and a metadata column 214. The example resources description column 212 specifies the type(s) of resources available for the corresponding data lakes. For example, for the first and second data lake entries 208a-b, the available resources listed in the resources description column 112 include services.

The services may be used to access and/or process any data in data tables of the data lakes 208a-b for which the user 202 has permissions to access. For example, if the user 202 is an authorized user of the first data lake 112a (e.g., the first data lake 112a is the local or home data lake of the user 202) and requests access to a compute service in the first data lake 112a, the user may use that compute service in the first data lake 112a to process any data that the user 202 has permissions to access in the first data lake 112a. Similarly, if the user 202, being an authorized user of the first data lake 112a, requests federated access to a compute service in the second data lake 112b and the user has permission to access that compute service, the user may use that compute service in the second data lake 112b (by federated access via the first data lake 112a) to process any data that the user 202 has permissions to access in the second data lake 112b. In yet another example, if the user 202 is an authorized user of the third data lake 112c (FIG. 1) and requests federated access to a compute service in the first data lake 112a, the user may use that compute service in the first data lake 112a, provided the user has permission to access that compute service, to process any data that the user 202 has permissions to access in the third data lake 112c.

The example metadata column 214 includes descriptions of data domains and usage policies corresponding to the available resources. For example, for the first and second data lake entries 208a-b, the discovery service 118a of the federation repository server 102 formats metadata in the metadata column 214 to include descriptions of available service resources such as storage, compute, and SQL database. The metadata for the first data lake entry 208a specifies a storage resource type for the storage service as S3 (e.g., Amazon Simple Storage Service), a compute resource type for the compute service as LIVY, and a data warehouse resource type for the SQL database service as HIVE. The metadata for the second data lake entry 208b specifies a storage resource type for the storage service as WEBHDFS (e.g., a Web Hadoop Distributed File System), a compute resource type for the compute service as LIVY, and a data warehouse resource type for the SQL database service as HIVE. The metadata for the SQL database service in both data lake entries 208a-b specifies usage policies that specify use of secure socket layer (SSL) as the connection type (e.g., SSL=TRUE) and hypertext transfer protocol as the transport mode (e.g., TRANSPORTMODE=HTTP). The metadata also specifies an access method of accessing the SQL database service as based on calls using Java database connectivity (JDBC).

After receiving the discovery result 132 at the client application 108, the client application 108 may display the information of the discovery result 132 via a user interface on a computer display for inspection by the user 202. The user 202 may inspect the information of the discovery result 132 and select one or more services of the data lakes 112a-b for which to request access.

FIG. 3 is an example messaging exchange between the client application 108 and the discovery service API 116a during a resource access process 300. In example FIG. 3, the client application 108 uses federation API calls to request access to one or more services of the federated data lakes 112a-b in response to a user selection request 302. For example, in response to the user selection request 302 from the user 202, the client application 108 uses a federation API call to generate the token request 134 of FIG. 1 and causes transmission of the token request 134 to the discovery service API 116a. The example token request 134 includes the mount name of the one of the federated data lakes 112a-b identified in the user selection request 302. After the discovery service API 116a receives the user selection request 302, the discovery service 118a determines whether the user 202 has permission to access the selected data lake 112a-b. For example, the discovery service 118a can determine whether the user 202 has permission to access the requested data lake 112a-b based on a user class or user type assigned to the user 202 and/or based on a username or user identifier of the user 202. For example, a permissions policy for the selected data lake 112a-b may specify particular user classes or user types as authorized to access that data lake 112a-b. Additionally or alternatively, the permissions policy for the selected data lake 112a-b may specify particular users based on usernames or user identifiers as authorized to access that data lake.

If the user 202 is not authorized to access the selected data lake 112a-b, the discovery service API 116a causes transmission of a permission denied message to the client application 108. However, if the user 202 is authorized to access the selected data lake 112a-b, the discovery service 118a obtains an access token from, for example, the trusted token authority 106 (FIG. 1) and metadata for the requested data lake 112a-b. The trusted token authority 106 authenticates the access token to access the requested data lake 112a-b and its services. The discovery service 118a adds the access token and the metadata in the access token and metadata message 136.

The example access token and metadata message 136 includes an access token field 304, a target URL field 306, a token type field 308, a services field 312, and an expiration field 314. The example token field 304 includes the access token issued by the trusted token authority 106. The access token includes one or more claims that limit the access token for use to access the selected data lake 112a-b specified in the token request 134. Limiting access to a data lake peer (e.g., ones of the data lakes 112a-c) specified by the claim of the access token limits a blast radius of a compromised token.

In example FIG. 3, the discovery service 118a formats metadata corresponding to the use of the access token into the target URL field 306, the token type field 308, the services field 312, and the expiration field 314. For example, the target URL field 306 includes a target URL of a service access endpoint 110a-b through which the selected data lake 112a-b may be accessed. The example token type field 308 specifies the token type of the access token as a bearer token. The example services field 312 identifies the services of the selected data lake 112a-b to which access was requested in the token request 134. In example FIG. 3, the services field 312 identifies JDBC calls as the method of accessing the SQL database service. The example expiration field 314 includes an expiration time and date at which the access token will expire. The expiration field 314 implements a limited lifespan of the access token which can be used to limit damage that could result from a compromised token.

After the access token and corresponding metadata are populated in the access token and metadata message 136, the discovery service API 116a causes transmission of the access token and metadata message 136 to the client application 108 in responses to the token request 134. After receiving the access token and metadata message 136 at the client application 108, the example client application 108 makes the information of the access token and metadata message 136 available to the user 202 for accessing the requested resources.

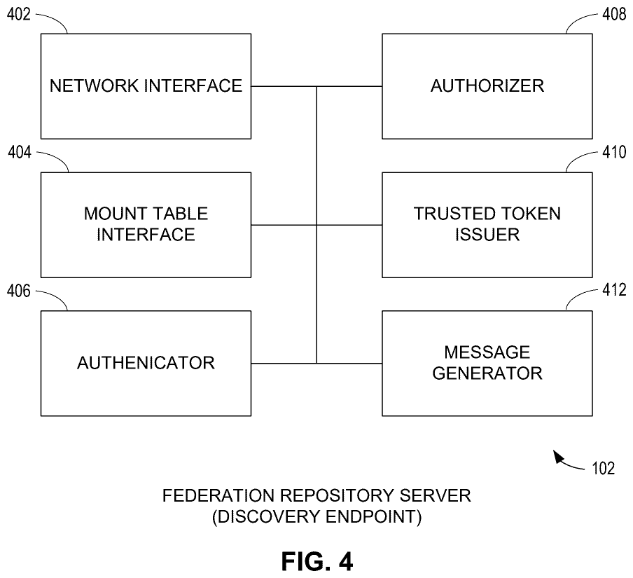

FIG. 4 is a block diagram of an example implementation of the federation repository server 102 of FIGS. 1-3. The federation repository server 102 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the federation repository server 102 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The federation repository server 102 includes an example network interface 402, an example mount table interface 404, an example authenticator 406, an example authorizer 408, an example trusted token issuer 410, and an example message generator 412. The example network interface 402, the example mount table interface 404, the example authenticator 406, the example authorizer 408, and the example trusted token issuer 410 may be used to implement the discovery service 118a in the federation repository server 102 (FIG. 1) to perform authentication and authorization and to issue access tokens.

The network interface 402 is provided to enable the federation repository server 102 to communicate with other entities via one or more networks. For example, the network interface 402 enables the federation repository server 102 to communicate with the client application 108 and with the trusted token authority 106. The mount table interface 404 is provided to enable the federation repository server 102 to access the mount table 104. The authenticator 406 is provided to enable the federation repository server 102 to authenticate access tokens.

The authorizer 408 is provided to determine permissions of users corresponding to federated data lakes (e.g., the data lakes 112a-c) and/or resources to which a user requests access (e.g., via the token request 134). For example, the authorizer 408 may determine permissions based on one or more policies of the data lakes 112a-c and/or resources based on one or more of organizations, user classes, or user types.

In example FIG. 4, the federation repository server 102 is provided with the trusted token issuer 410 to issue access tokens. In such examples, the trusted token authority 106 of FIG. 1 is implemented in the federation repository server 102 as the trusted token issuer 410. Alternatively, if the federation repository server 102 is provided with the trusted token issuer 410, the federation repository server 102 communicates with the separate trusted token authority 106 of FIG. 1 to receive access tokens.

The federation repository server 102 is provided with the example message generator 412 to generate messages such as the discovery result 132 and the access token and metadata message 136 of FIG. 1. The message generator 412 causes the network interface 402 to transmit such messages via a network. For example, the message generator 412 causes the network interface 402 to transmit the discovery result 132 and the access token and metadata message 136 to the client application 108.

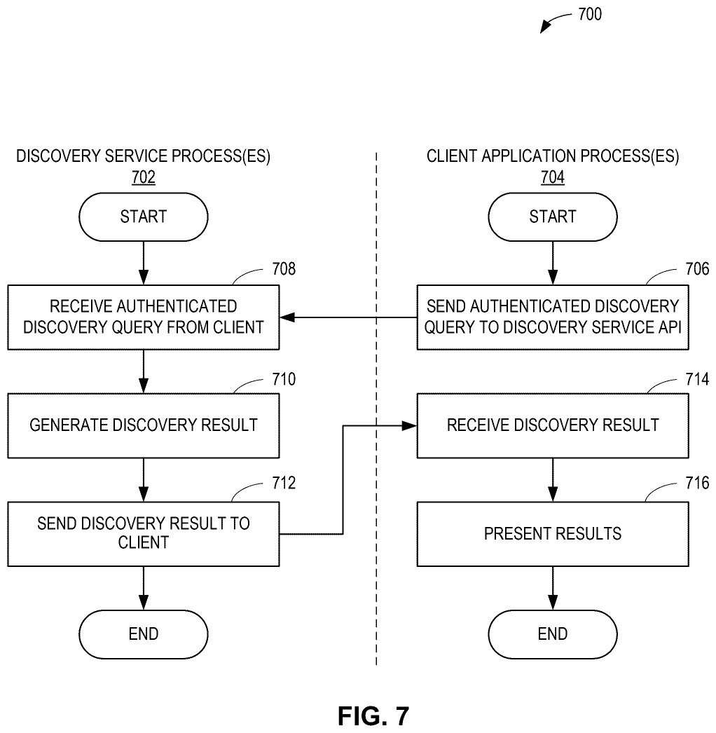

In some examples, the network interface 402, the mount table interface 404, the authenticator 406, the authorizer 408, the trusted token issuer 410, and the message generator 412 are circuitry (e.g., network interface circuitry, mount table interface circuitry, authenticator circuitry, authorizer circuitry, trusted token issuer circuitry, and message generator circuitry) instantiated by programmable circuitry executing instructions and/or configured to perform operations such as those represented by the flowcharts of FIGS. 7 and 8.

As described above, the network interface 402, the mount table interface 404, the authenticator 406, the authorizer 408, the trusted token issuer 410, and the message generator 412 of FIG. 4 are structures. Such structures may implement means for performing corresponding disclosed functions. Examples of such functions are described above in connection with corresponding ones of the network interface 402, the mount table interface 404, the authenticator 406, the authorizer 408, the trusted token issuer 410, and the message generator 412 and are described below in connection with the flowcharts of FIGS. 7 and 8.

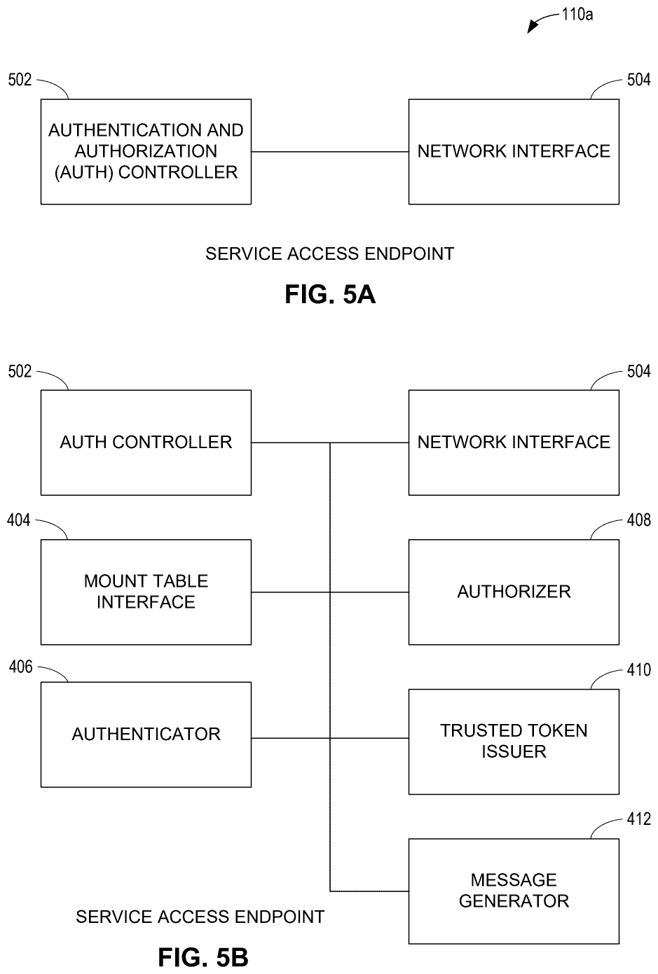

FIGS. 5A and 5B are block diagrams of example implementations of the service access endpoint 110a of FIG. 1. The service access endpoints 110b of FIG. 1 is substantially similar or identical to the service access endpoint 110a. As such, for purposes of brevity, only the structures of the service access endpoint 110a are shown and described in connection with FIGS. 5A and 5B. The service access endpoint 110a of FIGS. 5A and 5B may be instantiated (e.g., creating an instance of, bring into being for any length of time, materialize, implement, etc.) by programmable circuitry such as a Central Processor Unit (CPU) executing first instructions. Additionally or alternatively, the service access endpoint 110a of FIGS. 5A and 5B may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIGS. 5A and 5B may, thus, be instantiated at the same or different times. Some or all of the circuitry of FIGS. 5A and 5B may be instantiated, for example, in one or more threads executing concurrently on hardware and/or in series on hardware. Moreover, in some examples, some or all of the circuitry of FIGS. 5A and 5B may be implemented by microprocessor circuitry executing instructions and/or FPGA circuitry performing operations to implement one or more virtual machines and/or containers.

In example FIG. 5A, the example service access endpoint 110a includes an example authentication and authorization (AUTH) controller 502 and an example network interface 504. The example AUTH controller 502 may be used to implement the AUTH controllers 113a-b of FIG. 1. The example AUTH controller 502 is to verify authenticity of access tokens in resource requests (e.g., the resource request 138 of FIG. 1). For example, the AUTH controller 502 receives public keys form the trusted token authority 106 of FIG. 1 (or the trusted token issuer 410 of FIG. 4). The AUTH controller 502 may then use such public keys to verify authenticity of the access tokens.

The example network interface 504 enables the service access endpoint 110a to communicate with other entities via one or more networks. For example, the network interface 504 enables the service access endpoint 110a to communicate with the client application 108, the federation repository server 102, the trusted token authority 106, and the other service access endpoints 110b-c.

FIG. 5B shows an alternative example implementation of the service access endpoint 110a in which the service access endpoint 110a includes the discovery service API 116b and the discovery service 118b. In such implementations, the service access endpoint 110a also includes the mount table interface 404, the authenticator 406, the authorizer 408, the trusted token issuer 410, and the message generator 412 as shown in FIG. 5B. The example implementation of the service access endpoint 110a in FIG. 5B may be used when the messaging exchange of the authenticated discovery query 128, the discovery result 132, the token request 134, and the access token and metadata message 136 of FIG. 1 is performed between the client application 108 and the discovery service API 116b in the service access endpoint 110a. In such examples, the federation repository server 102 of FIG. 1 may be omitted from the resource federation system 100. Descriptions of the mount table interface 404, the authenticator 406, the authorizer 408, the trusted token issuer 410, and the message generator 412 are not repeated here. Instead, the interested reader is referred to the corresponding descriptions provided above in connection with FIG. 4.

In some examples, the authentication and authorization (AUTH) controller 502, the network interface 504, the mount table interface 404, the authenticator 406, the authorizer 408, the trusted token issuer 410, and the message generator 412 of FIG. 5A or 5B are circuitry (e.g., authentication and authorization (AUTH) controller circuitry, network interface circuitry, mount table interface circuitry, authenticator circuitry, authorizer circuitry, trusted token issuer circuitry, and the message generator circuitry) instantiated by programmable circuitry executing instructions and/or configured to perform operations such as those represented by the flowcharts of FIGS. 7 and 8.

As described above, the authentication and authorization (AUTH) controller 502, the network interface 504, the mount table interface 404, the authenticator 406, the authorizer 408, the trusted token issuer 410, and the message generator 412 of FIG. 5A or 5B are structures. Such structures may implement means for performing corresponding disclosed functions. Examples of such functions are described above in connection with corresponding ones of the authentication and authorization (AUTH) controller 502, the network interface 504, the mount table interface 404, the authenticator 406, the authorizer 408, the trusted token issuer 410, and the message generator 412 and are described below in connection with the flowcharts of FIGS. 7 and 8.

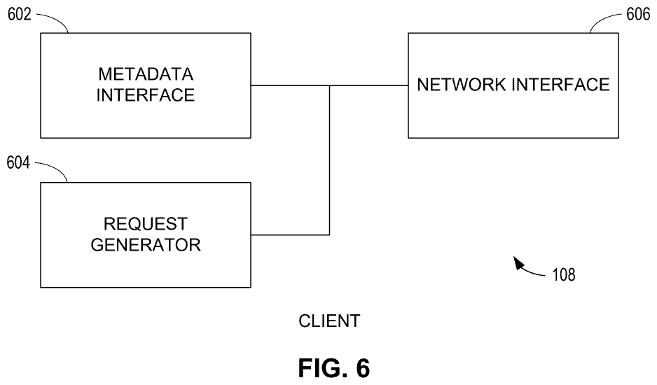

FIG. 6 is a block diagram of an example implementation of the client application 108 of FIGS. 1-3. The client application 108 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the client application 108 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The example client application 108 Includes an example metadata interface 602, an example request generator 604, and an example network interface 606. The metadata interface 602 is to access information in the discovery result 132 (FIGS. 1 and 2. The request generator 604 is to generate the authenticated discovery query 128, the token request 134, and the resource request 138 of FIG. 1. The example network interface 606 enables the client application 108 to communicate with other entities via one or more networks. For example, the network interface 606 enables the client application 108 to communicate with the federation repository server 102 and the service access endpoints 110a-c.

In some examples, the metadata interface 602, the request generator 604, and the network interface 606 of FIG. 6 are circuitry (e.g., metadata interface circuitry, request generator circuitry, and network interface circuitry) instantiated by programmable circuitry executing instructions and/or configured to perform operations such as those represented by the flowcharts of FIGS. 7 and 8.

As described above, the metadata interface 602, the request generator 604, and the network interface 606 of FIG. 6 are structures. Such structures may implement means for performing corresponding disclosed functions. Examples of such functions are described above in connection with corresponding ones of the metadata interface 602, the request generator 604, and the network interface 606 and are described below in connection with the flowcharts of FIGS. 7 and 8.

While an example manner of implementing the the federation repository server 102, the service access endpoint 110a, and the client application 108 of FIG. 1 are illustrated in corresponding ones of FIGS. 4, 5A, 5B, and 6, one or more of the elements, processes, and/or devices illustrated in FIGS. 4, 5A, 5B, and 6 may be combined, divided, re-arranged, omitted, eliminated, and/or implemented in any other way. Further, the network interface 402, the mount table interface 404, the authenticator 406, the authorizer 408, the trusted token issuer 410, the message generator 412, the authentication and authorization (AUTH) controller 502, the network interface 504, the metadata interface 602, the request generator 604, the network interface 606 and/or, more generally, the federation repository server 102 of FIG. 4, the service access endpoint 110a of FIGS. 5A and/or 5B, and the client application 108 of FIG. 6, may be implemented by hardware alone or by hardware in combination with software and/or firmware. Thus, for example, any of the network interface 402, the mount table interface 404, the authenticator 406, the authorizer 408, the trusted token issuer 410, the message generator 412, the authentication and authorization (AUTH) controller 502, the network interface 504, the metadata interface 602, the request generator 604, the network interface 606 and/or, more generally, the federation repository server 102, the service access endpoint 110a, and the client application 108, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the federation repository server 102 of FIG. 4, the service access endpoint 110a of FIGS. 5A and/or 5B, and the client application 108 of FIG. 6 may include one or more elements, processes, and/or devices in addition to, or instead of, those illustrated in FIGS. 4, 5A, 5B, and 6, and/or may include more than one of any or all of the illustrated elements, processes and devices.

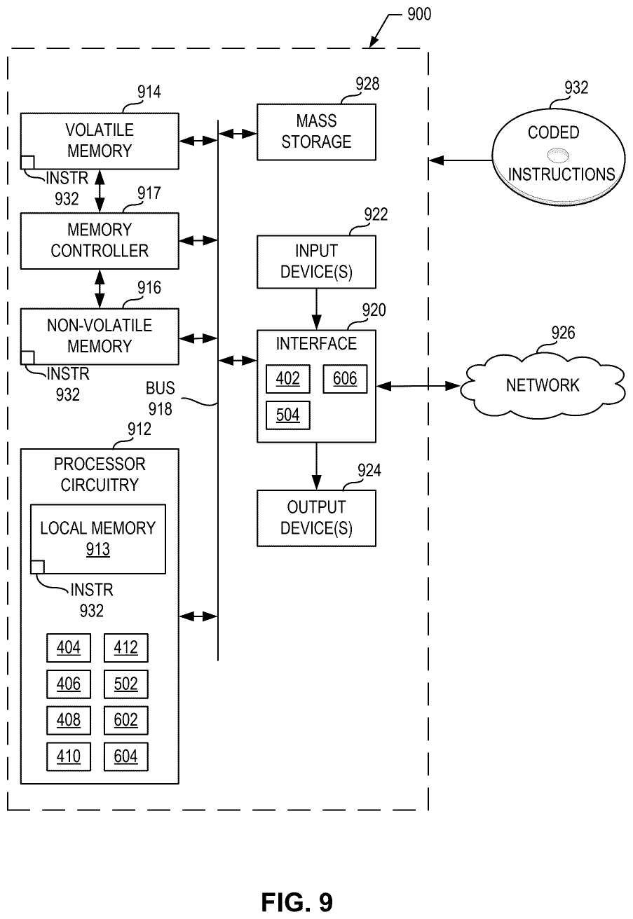

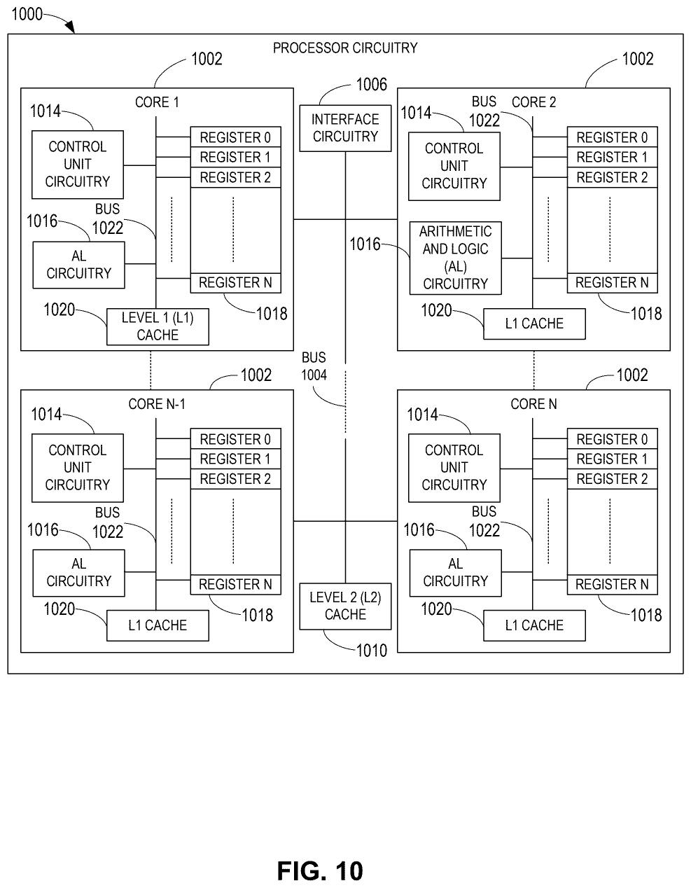

Flowchart(s) representative of example machine-readable instructions, which may be executed by programmable circuitry to implement and/or instantiate the federation repository server 102 of FIG. 4, the service access endpoint 110a of FIGS. 5A and/or 5B, and the client application 108 of FIG. 6 and/or representative of example operations which may be performed by programmable circuitry to implement and/or instantiate the federation repository server 102, the service access endpoint 110a, and the client application 108, are shown in FIGS. 7 and 8. The machine-readable instructions may be one or more executable program(s) or portion(s) of one or more executable program(s) for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer-readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer-readable storage medium may include one or more mediums and/or types of mediums. The instructions of the non-transitory computer-readable and/or machine-readable medium may be executed and/or instantiated by one or more hardware devices other than the programmable circuitry and/or may be embodied in dedicated hardware. For example, any or all of the blocks of the flowchart(s) may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowchart(s) illustrated in FIGS. 7 and 8, many other methods of implementing the federation repository server 102, the service access endpoint 110a, and the client application 108 may alternatively be used. For example, the order of execution of the blocks of the flowchart(s) may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

Machine-readable instructions as described herein may be stored as data and/or in a data structure (e.g., as portion(s) of instructions, code, representations of code, etc.) on one or more storage devices, disks and/or computing devices (e.g., servers) located at the same or different locations of a network or collection of networks (e.g., in the cloud, in edge devices, etc.).

The machine-readable instructions described herein can be written or represented using any suitable previously developed or future-developed instruction language, scripting language, programming language, etc. including, for example, C, C++, Java, C#, Perl, Python, JavaScript, HyperText Markup Language (HTML), Structured Query Language (SQL), Swift, etc.

As mentioned above, the example operations of FIGS. 7 and 8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc. As used herein, the term “storage disk” refers to a physical structure containing information storage elements to which information can be written and persisted for subsequent retrieval by a computer or other hardware platform.

Examples of non-transitory computer-readable medium, non-transitory computer-readable storage medium, non-transitory machine-readable medium, non-transitory machine-readable storage medium, non-transitory computer-readable storage devices, non-transitory machine-readable storage devices, non-transitory computer-readable storage disk, and/or non-transitory machine-readable storage disk include any one of or combination of random access memory (RAM) of any type, read only memory (ROM) of any type, solid state memory, flash memory, optical discs (e.g., a CD, a DVD, etc.), magnetic disks (e.g., magnetic HDDs), disk drives, cache, registers, redundant array of independent disks (RAID) systems, and/or any other non-transitory computer-readable and/or machine-readable media in which information is stored for any duration (e.g., for extended time periods, permanently, for brief instances, for temporarily buffering, and/or for caching of the information).

FIG. 7 is a flowchart representative of example machine-readable instructions and/or example operations 700 that may be executed, instantiated, and/or performed by example programmable circuitry to implement the discovery services 118a-b of FIGS. 1-4 and/or the client application 108 of FIGS. 1-3 and 6 to discover federated resources during a discovery process (e.g., the discovery process 200 of FIG. 2). The instructions and/or operations 700 are described in connection with the discovery service 118a at the federation repository server 102. However, the same instructions and/or operations 700 may implement the discovery service 118b at the service access endpoint 110a. As shown in FIG. 7, ones of the instructions and/or operations 700 are executed in a discovery service process 702 of the discovery service 118a and other ones of the instructions and/or operations 700 are executed in a client application process 704 of the client application 108.

The instructions 700 of FIG. 7 begin at block 706 at which the network interface 606 (FIG. 6) of the client application 108 sends the authenticated discovery query 128 (FIGS. 1 and 2) to the discovery service API 116a. For example, the request generator 604 (FIG. 6) generates the authenticated discovery query 128 in response to receiving the discovery request 204 (FIG. 2) from the user 202 and causes the network interface 606 to transmit the authenticated discovery query 128 to the federation repository server 102. The request generator 604 generates the authenticated discovery query 128 using a federation API call compatible with the discovery service API 116a.

The example network interface 402 (FIG. 4) of the federation repository server 102 receives the authenticated discovery query 128 from the client application 108 (block 708). The message generator 412 (FIG. 4) generates the discovery result 132 (FIGS. 1 and 2) (block 710). For example, the mount table interface 404 (FIG. 4) accesses the mount table 104 to determine federated data lakes and resources exposed by those federated data lakes and provides the mount names of the federated data lakes and resource names of the exposed resources to the message generator 412. The message generator 412 adds the mount names of the federated data lakes in data lake entries (e.g., the data lake entries 208a-b of FIG. 2) of the discovery result 132 and adds the resource names of the exposed resources in the resources description column 212. Also at block 710, the message generator 412 adds descriptions of data domains and usage policies corresponding to the available resources in the metadata column 214 of the discovery result 132. In example FIG. 7, the message generator 412 generates the discovery result 132 using a response format as defined by the discovery service API 116a.

The example network interface 402 sends the discovery result 132 to the client application 108 (block 712). The network interface 606 (FIG. 6) of the client application 108 receives the discovery result 132 from the discovery service 118a (block 714). The metadata interface 602 causes presentation of the results in the discovery result 132 (block 716). That is, the metadata interface 602 provides the results to an output device such as a display so that the user 202 can inspect the results. For example, after the network interface 606 of the client application 108 receives the discovery result 132 from the federation repository server 102, the metadata interface 602 accesses the mount names of ones of the data lakes 112a-c from the discovery result 132. The metadata interface 602 also obtains resource descriptions form the resources description column 212 of the discovery result 132, and descriptions of data domains and usage policies from the metadata column 214 of the discovery result 132. This information is then presented to the user 202 to allow the user 202 to select one or more of the federated data lakes and/or resources to which access is to be requested. The example instructions and/or operations 700 of FIG. 7 end.

FIG. 8 is a flowchart representative of example machine-readable instructions and/or example operations 800 that may be executed, instantiated, and/or performed by example programmable circuitry to implement the discovery service 118a of FIGS. 1-3, the client application 108 of FIGS. 1-3 and 6, and/or the service access endpoint 110a of FIGS. 1, 5A, and 5B during a resource access process (e.g., the resource access process 300 of FIG. 3). The example instructions and/or operations 800 of the resource access process 300 may be performed after the instructions and/or operations 700 of FIG. 7 corresponding to the discovery process 200.

As shown in FIG. 8, ones of the instructions and/or operations 800 are executed in a discovery service process 802, ones of the instructions and/or operations 800 are executed in a client application process 804 of the client application 108, and ones of the instructions and/or operations 800 are executed in a service access endpoint process 806 of the service access endpoint 110a. Although FIG. 8 is described relative to the service access endpoint 110a, the service access endpoints 110b-c may be implemented to operate substantially similarly or identically to the service access endpoint 110a. In addition, ones of the instructions and/or operations 800 corresponding to the discovery service process 802 are described in connection with the discovery service 118a at the federation repository server 102. However, the same instructions and/or operations 800 may implement the discovery service 118b at the service access endpoint 110a. The instructions and/or operations 800 are described in connection with a user requesting access to a single one of the data lakes 112a-c (FIG. 1) and a single service of that data lake. However, the same instructions and/or operations 800 may be used to request access to multiple data lakes and services by executing multiple iterations of the instructions and/or operations 800.

The instructions 800 of FIG. 8 begin at block 812 at which the network interface 606 (FIG. 6) sends the token request 134 (FIGS. 1 and 3) to the federation repository server 102. For example, after the user 202 (FIGS. 2 and 3) makes a selection of a data lake (e.g., one of the data lakes 112a-c) to access, the request generator 604 (FIG. 6) generates the token request 134 using an API call format compatible with the discovery service API 116a and includes authentication credentials (e.g., a username and password, a time-based password code, a passkey, etc.) of the user 202 and the mount name of the selected data lake in the token request 134. The request generator 604 then causes the network interface 606 to transmit the token request 134 to the federation repository server 102.

The network interface 402 (FIG. 4) of the federation repository server 102 receives the token request 134 (block 814) to be processed by the discovery service 118a. At block 816, the authenticator 406 (FIG. 4) authenticates the user 202 based on the authentication credentials in the token request 134. For example, the authenticator 406 may confirm the authentication credentials to confirm the authenticity of the user 202. At block 818, the authorizer 408 (FIG. 4) determines whether the user account of the user 202 has permissions to access the requested data lake. For example, the authorizer 408 may access a permissions policy for the requested data lake. In such examples, the permissions policy specifies particular user classes or user types as authorized to access the requested data lake. Additionally or alternatively, the permissions policy for the requested data lake may specify particular users based on usernames or user identifiers as authorized to access the requested data lake.

If the authorizer 408 determines that the user 202 is not authorized to access the requested data lake, (block 818: NO), the network interface 402 sends a permission denied message to the client application 108 (block 820). For example, the message generator 412 generates the permission denied message using a format specified by the discovery service API 116a and causes the network interface 402 to send the message. If the authorizer 408 determines that the user 202 is authorized to access the requested data lake, (block 818: YES), the authorizer 408 obtains an access token (block 822). For example, the authorizer 408 obtains an access token from the trusted token issuer 410 (FIG. 4). If the requested data lake specified in the token request 134 is the first data lake 112a, the trusted token issuer 410 includes a claim in the access token to limit the access token for use with the first data lake 112a and its resources. Alternatively, if the requested data lake specified in the token request 134 is in the second data lake 112b, the trusted token issuer 410 includes a claim in the access token to limit use of the access token to access the second data lake 112b and its resources. In such example, if the user 202 is a registered user of the first data lake 112a, the user 202 can access the second data lake 112b from the first data lake 112a.

The message generator 412 (FIG. 4) generates the access token and metadata message 136 (block 824). For example, the message generator 412 obtains the access token issued by the trusted token issuer 410 and obtains metadata from the mount table 104 corresponding to ones of the federated data lakes 112a-c and/or one or more resources requested in the token request 134. The message generator 412 then adds the access token and the metadata to the access token and metadata message 136 as described above in connection with FIG. 3. The example network interface 402 sends the access token and metadata message 136 to the client application 108 (block 826).

At block 828, the network interface 606 at the client application 108 receives the access token and metadata message 136 from the discovery service 118a. The request generator 604 generates the resource request 138 (block 830). For example, after the client application 108 receives the access token and metadata message 136, the request generator 604 generates the resource request 138 (FIG. 1) by adding the access token, a target URL (e.g., a target URL in the target URL field 306 of FIG. 3) of the data lake selected by the user 202, and a service name provided in the access token and metadata message 136 for a service to be accessed by the user 202 in the data lake. The network interface 606 sends the resource request 138 to the service access endpoint 110a (block 832). For example, the request generator 604 causes the network interface 606 to use the target URL of the selected data lake to transmit the resource request 138 to the service access endpoint 110a using one or more usage policies (e.g., usage policies that specify use of SSL as the connection type, hypertext transfer protocol as the transport mode, etc.) and an access method (e.g., a Java database connectivity (JDBC) access method) specified in the access token and metadata message 136 for the service to be accessed by the user 202 in the data lake.

At block 834, the network interface 504 (FIGS. 5A and 5B) of the service access endpoint 110a receives the resource request 138. The AUTH controller 502 determines whether the access token in the resource request 138 authenticates and authorizes access to the requested service specified in the resource request 138 (block 836). For example, the AUTH controller 502 uses a public key to authenticate the access token. In addition, the AUTH controller 502 accesses one or more policies of (e.g., published by) the service access endpoint 110a corresponding to the first data lake 112a to confirm whether the user 202 corresponding to the access token is authorized to access the requested service. For examples in which the resource request 138 specifies a service in the second or third data lakes 112b-c, the AUTH controller 502 accesses one or more policies corresponding to (e.g., published by) the second data lake 112b or the third data lake 112c to confirm whether the user 202 is authorized to access the service therein.

If the AUTH controller 502 determines that the access token does not authenticate and/or the user 202 corresponding to the access token is not authorized to access the requested service (block 836: NO), the network interface 504 sends an access denial notification to the client application 108 (block 838). Alternatively, if the AUTH controller 502 determines that the access token does authenticate and the user 202 corresponding to the access token is authorized to access the requested service (block 836: YES), the AUTH controller 502 provides access to the requested service (block 840). The example instructions 800 of FIG. 8 end.

FIG. 9 is a block diagram of an example programmable circuitry platform 900 structured to execute and/or instantiate the example machine-readable instructions and/or the example operations of FIGS. 7 and 8 to implement the federation repository server 102 of FIG. 4, the service access endpoint 110a of FIGS. 5A and/or 5B, and the client application 108 of FIG. 6. The programmable circuitry platform 900 can be, for example, a server, a personal computer, a workstation, a self-learning machine (e.g., a neural network), or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, XPUs, and/or microcontrollers from any desired family or manufacturer. The programmable circuitry 912 may be implemented by one or more semiconductor based (e.g., silicon based) devices. In this example, the programmable circuitry 912 implements the mount table interface 404, the authenticator 406, the authorizer 408, the trusted token issuer 410, and the message generator 412 of FIG. 4; the authentication and authorization (AUTH) controller 502 of FIG. 5; and the metadata interface 602 and the request generator 604 of FIG. 6.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, a keyboard, a button, a mouse, a touchscreen, a trackpad, a trackball, etc.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, etc. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In example FIG. 9, the interface circuitry 920 may implement the network interface 402 of FIG. 4, the network interface 504 of FIGS. 5A and 5B, and/or the network interface 606 of FIG. 6.

The programmable circuitry platform 900 of the illustrated example also includes one or more mass storage discs or devices 928 to store firmware, software, and/or data. Examples of such mass storage discs or devices 928 include magnetic storage devices, optical storage devices, RAID systems, and/or solid-state storage discs or devices such as flash memory devices and/or SSDs.

The machine-readable instructions 932, which may be implemented by the machine-readable instructions of FIGS. 7 and/or 8, may be stored in the mass storage device 928, in the volatile memory 914, in the non-volatile memory 916, and/or on at least one non-transitory computer-readable storage medium which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 and/or components thereof may include additional and/or alternate structures to those shown and described below. The microprocessor 1000 is a semiconductor device fabricated to include transistors interconnected to implement the structures described below in one or more integrated circuits (ICs) contained in one or more packages.

The microprocessor 1000 executes machine-readable instructions of the flowcharts of FIGS. 7 and/or 8 to instantiate the circuitry of FIGS. 4, 5A, 5B, and 6 as logic circuits to perform operations corresponding to those machine-readable instructions. In some such examples, the circuitry of FIGS. 4, 5A, 5B, and 6 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program represented by the flowchart(s) of FIGS. 7 and/or 8 may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 7 and/or 8.

The cores 1002 may communicate by a first example bus 1004. For example, the first bus 1004 may be implemented by any suitable bus technology (e.g., an Inter-Integrated Circuit (I2C) bus, a Serial Peripheral Interface (SPI) bus, a PCI bus, a PCIe bus, etc.). Data, instructions, and/or signals may be communicated (e.g., accessed, obtained, output, provided, etc.) between the cores 1002 and one or more external devices by example interface circuitry 1006. Although the cores 1002 of this example include example local cache 1020 (e.g., Level 1 (L1) cache that may be split into an L1 data cache and an L1 instruction cache), the microprocessor 1000 also includes example shared cache 1010. The shared cache 1010 is shared by the cores (e.g., Level 2 (L2 cache)) to access data and/or instructions across the cores.

Each core 1002 includes control unit circuitry 1014, arithmetic and logic (AL) circuitry (sometimes referred to as an arithmetic logic unit (ALU)) 1016, a plurality of registers 1018 (e.g., hardware registers), the local cache 1020, and a second example bus 1022. The control unit circuitry 1014 controls (e.g., coordinates) data movement within the corresponding core 1002. The AL circuitry 1016 performs one or more mathematic and/or logic operations on the data within the corresponding core 1002.

The registers 1018 store data and/or instructions such as results of operations performed by the AL circuitry 1016. The second bus 1022 may be implemented using any suitable bus technology (e.g., an I2C bus, a SPI bus, a PCI bus, or a PCIe bus, etc.).

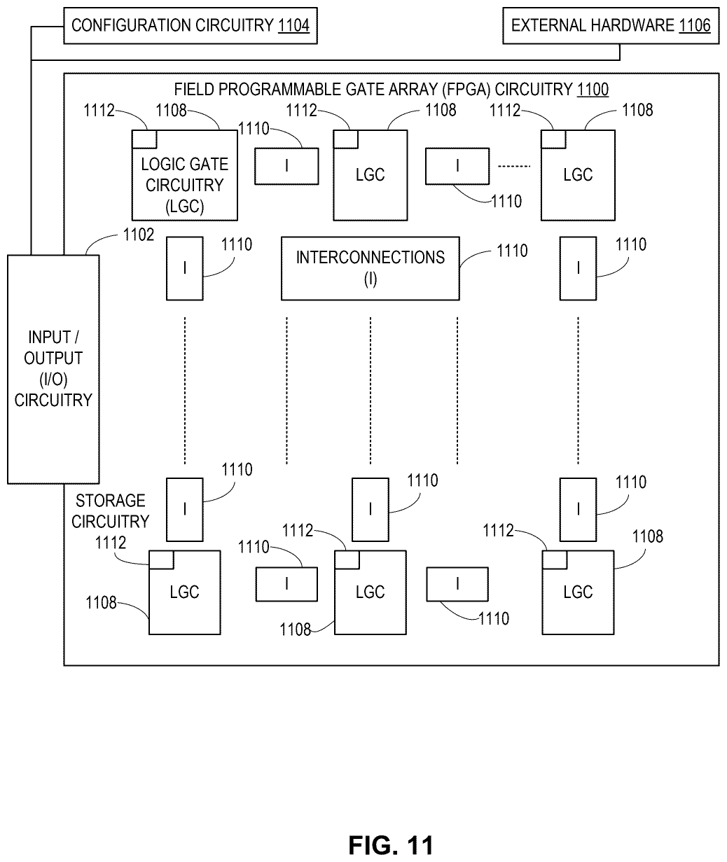

FIG. 11 is a block diagram of another example implementation of the programmable circuitry 912 of FIG. 9. In this example, the programmable circuitry 912 is implemented by FPGA circuitry 1100. Programmable logic circuitry of the FPGA circuitry 1100 may be programmed to create dedicated logic circuits that perform operations and/or functions represented in the flowchart(s) of FIGS. 7 and/or 8. For example, the FPGA circuitry 1100 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowchart(s) of FIGS. 7 and/or 8. After an FPGA programming process, the FPGA circuitry 1100 instantiates the operations and/or functions corresponding to the machine-readable instructions in hardware. In some examples, the FPGA circuitry 1100 can execute the operations/functions faster than they could be performed by a general-purpose microprocessor.

The FPGA circuitry 1100 of FIG. 11, includes example input/output (I/O) circuitry 1102 to obtain data from and/or output data to example configuration circuitry 1104 and/or external hardware 1106 (e.g., microprocessor circuitry, controller circuitry, memory circuitry, storage circuitry, a computer, etc.). For example, the configuration circuitry 1104 may be implemented by interface circuitry that obtains a binary file to program or configure the FPGA circuitry 1100.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to machine-readable instructions of FIGS. 7 and/or 8 and/or other desired operations.

The storage circuitry 1112 is structured to store result(s) of operations performed by corresponding logic gates. The storage circuitry 1112 may be implemented by registers or the like.

Although not shown, the example FPGA circuitry 1100 of FIG. 11 also includes example dedicated operations circuitry to implement functions without programming those functions in the logic gate circuitry 1108. The FPGA circuitry 1100 may also include general purpose programmable circuitry such as a CPU, a DSP, etc.

Although FIGS. 10 and 11 illustrate two example implementations of the programmable circuitry 912 of FIG. 9, many other approaches are contemplated. For example, a hybrid circuitry example may include one or more cores 1002 of FIG. 10 that execute(s) a first portion of the machine-readable instructions represented by the flowchart(s) of FIGS. 7 and/or 8 to perform first operation(s)/function(s), and/or include the FPGA circuitry 1100 of FIG. 11 configured and/or structured to perform second operation(s)/function(s) corresponding to a second portion of the machine-readable instructions represented by the flowcharts of FIGS. 7 and/or 8, and/or include an ASIC configured and/or structured to perform third operation(s)/function(s) corresponding to a third portion of the machine-readable instructions represented by the flowcharts of FIGS. 7 and/or 8.

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 912 of FIG. 9 may be in one or more packages. For example, the microprocessor 1000 of FIG. 10 and/or the FPGA circuitry 1100 of FIG. 11 may be in one or more packages.

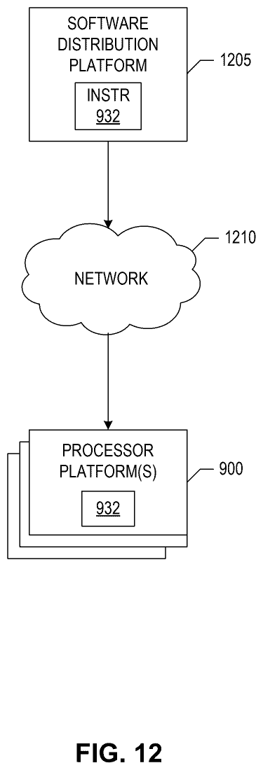

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. In the illustrated example, the software distribution platform 1205 includes one or more servers and one or more storage devices. The storage devices store the machine-readable instructions 932, which may correspond to the example machine-readable instructions of FIGS. 7 and/or 8, as described above. The one or more servers of the example software distribution platform 1205 are in communication with an example network 1210, which may correspond to any one or more of the Internet and/or any of the example networks described above. The servers enable downloading the machine-readable instructions 932 from the software distribution platform 1205. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include any circuitry that can be programmed or configured to perform different operations and that includes one or more semiconductor-based logic devices (e.g., electrical hardware implemented by one or more transistors. Programmable circuitry may be: (i) one or more special purpose electrical circuits (e.g., an ASIC) and/or (ii) one or more general purpose semiconductor-based electrical circuits programmable with instructions. Examples of programmable circuitry include programmable microprocessors such as CPUs, FPGAS, GPUs, DSPs, XPUs, Network Processing Units (NPUs), and/or integrated circuits such as ASICs. For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing tasks to whichever one(s) of the multiple types of programmable circuitry is/are suited and available to perform the computing tasks.

From the foregoing, it will be appreciated that example systems, apparatus, articles of manufacture, and methods have been disclosed that federate deployments and facilitate access to federated resources. Disclosed systems, apparatus, articles of manufacture, and methods improve the efficiency of using a computing device by federating resources across multiple deployments in a network environment and coordinating issuance of federation access tokens to users as part of resource access processes. As such, a federation access token is used to authorize a corresponding user to access multiple federated resources in the different deployments across one or more computer networks. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine-readable instructions; and
programmable circuitry to at least one of instantiate or execute the machine-readable instructions to:
cause transmission of a discovery result to a client application, the discovery result including a list of federated data lakes; and
after receipt of a token request specifying a first data lake of the federated data lakes, cause transmission of an access token and metadata to the client application, the access token and the metadata corresponding to the first data lake, the metadata to specify services available at the first data lake, the access token to grant the client application access to the first data lake of the federated data lakes.

2. The apparatus of claim 1, wherein the discovery result identifies the services corresponding to the first data lake and second services corresponding to a second data lake, the second services including at least one of a storage service, a compute service, or a database service.

3. The apparatus of claim 2, wherein the first data lake is in a private cloud and the second data lake is in a public cloud.

4. The apparatus of claim 1, wherein the access token is a JavaScript Object Notation (JSON) Web Token.

5. The apparatus of claim 1, wherein the programmable circuitry is to specify in the metadata a type of data warehouse of one of the services and a connection type to access the one of the services.

6. The apparatus of claim 1, wherein the programmable circuitry is to specify a storage service, a compute service, and a structured query language (SQL) service in the metadata, the storage service, the compute service, and the SQL service corresponding to the first data lake.

7. The apparatus of claim 6, wherein the programmable circuitry is to format the metadata to specify:
a target uniform resource locator corresponding to the first data lake;
a storage resource type corresponding to the storage service;
a compute resource type corresponding to the compute service; and
a data warehouse resource type corresponding to the SQL service.

8. The apparatus of claim 1, wherein the programmable circuitry is to include a target uniform resource locator corresponding to the first data lake and a token type of the access token in the metadata.

9.-11. (canceled)

12. A non-transitory machine-readable storage medium comprising instructions to cause programmable circuitry to at least:
cause transmission of a discovery result to a client application, the discovery result including a list of federated data lakes; and
after receipt of a token request specifying a first data lake of the federated data lakes, cause transmission of an access token and metadata to the client application, the access token and the metadata corresponding to the first data lake, the metadata to specify services available at the first data lake, the access token to grant the client application access to the first data lake of the federated data lakes.

13. The non-transitory machine-readable storage medium of claim 12, wherein the discovery result identifies the services corresponding to the first data lake and second services corresponding to a second data lake, the second services including at least one of a storage service, a compute service, or a database service.

14. The non-transitory machine-readable storage medium of claim 13, wherein the first data lake is in a private cloud and the second data lake is in a public cloud.

15. The non-transitory machine-readable storage medium of claim 12, wherein the access token is a JavaScript Object Notation (JSON) Web Token.

16. The non-transitory machine-readable storage medium of claim 12, wherein the instructions are to cause the programmable circuitry to specify in the metadata a type of data warehouse of one of the services and a connection type to access the one of the services.

17. The non-transitory machine-readable storage medium of claim 12, wherein the instructions are to cause the programmable circuitry to specify a storage service, a compute service, and a structured query language (SQL) service in the metadata, the storage service, the compute service, and the SQL service corresponding to the first data lake.

18. The non-transitory machine-readable storage medium of claim 17, wherein the instructions are to cause the programmable circuitry to format the metadata to specify:
a target uniform resource locator corresponding to the first data lake;
a storage resource type corresponding to the storage service;
a compute resource type corresponding to the compute service; and
a data warehouse resource type corresponding to the SQL service.

19. The non-transitory machine-readable storage medium of claim 12, wherein the instructions are to cause the programmable circuitry to include a target uniform resource locator of the first data lake and a token type of the access token in the metadata.

20. The non-transitory machine-readable storage medium of claim 12, wherein the client application is in a first cloud and the first data lake is in a second cloud separate from the first cloud.

21. The non-transitory machine-readable storage medium of claim 12, wherein the instructions are to cause the programmable circuitry to cause the transmission of the discovery result to the client application after receipt of authentication credentials of a user.

22. The non-transitory machine-readable storage medium of claim 12, wherein the instructions are to cause the programmable circuitry to obtain the access token from a trusted token authority.

23. A method comprising:
transmitting a discovery result to a client application, the discovery result including a list of federated data lakes; and
after receipt of a token request specifying a first data lake of the federated data lakes, causing, by at least one processor circuit programmed by at least one instruction, transmission of an access token and metadata to the client application, the access token and the metadata corresponding to the first data lake, the metadata to specify services available at the first data lake, the access token to grant the client application access to the first data lake of the federated data lakes.

24.-33. (canceled)
